(19) United States
(12) Patent Application Publication
(10) Pub. No.: US 2006/0133195 A1
(43) Pub. Date: Jun. 22, 2006

(54) Apparatus for mixing

(75) Inventors: Olof Melander, Sundsvall (SE); Peter Danielsson, Fagervik (SE); Tomas Wikstrom, Sundsvall (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Metso Paper, Inc., Helsinki (FI)

(21) Appl. No.: 10/537,938

(22) PCT Filed: Dec. 8, 2003
(86) PCT No.: PCT/SE03/01906

§ 371 Date: Oct. 27, 2005

(30) Foreign Application Priority Data
Dec. 12, 2002 (SE) 02036770

(51) Int. Cl. B01F 7/04; B01F 15/02

(52) U.S. Cl. 366/170.3; 366/171.1; 366/307; 366/325.2

(57) ABSTRACT

The present invention relates to an apparatus for mixing of a chemical medium in gaseous or liquid state with a pulp suspension. The apparatus comprises a housing having a wall (2) that defines a mixing chamber (4), a first feeder (6) for feeding the pulp suspension to the mixing chamber, a rotor shift (8, 204, 300, 406, 502), that extends in the mixing chamber, a drive device for rotation of the rotor shaft, a rotor body (10, 200, 407, 504), that is connected to the rotor shaft and arranged to supply kinetic energy to the pulp suspension flow, during rotation of the rotor shaft by the rotation of the drive device, such that turbulence is produced in a turbulent flow zone (12) in the mixing chamber, a second feeder (13) for feeding of the chemical medium to the mixing chamber, and an outlet for discharging the mixture of chemical medium and pulp suspension from the mixing chamber.

The present invention relates to an apparatus for mixing of a chemical medium in gas gaseous or liquid state with a pulp suspension.

In treatment of pulp suspensions there is a need for intermixture of different mediums for treatment, for example for heating or bleaching purposes. Therefore it is desirable to disperse the medium in the pulp suspension during simultaneous conveyance of the pulp suspension through a pipe. Patent EP 664150 discloses an apparatus for this function. For heating of pulp suspensions, steam is added which condense and therewith give off its energy content to the pulp suspension. A bleaching agent is added in bleaching that shall react with the pulp suspension. In connection Lo the treatment of recovered fibre pulp printing ink is separated by flotation, which means that air shall previously be disintegrated in the pulp suspension such that the hydrophobic ink, or the printing ink, may attach to the rising air bubbles. In this connection it is desirable that the medium for treatment, e.g. air, is evenly and homogeneously distributed in the pulp suspension, preferably with tiny bubbles to achieve a large surface against the pulp suspension.

In all cases it is hard, with proportionately low addition of energy, to achieve an even intermixture of the medium in the flow of material. When heating pulp suspensions by supply of steam to a pulp pipe, problems often arise with large steam bubbles that are formed on the inside of the pipe, this as a consequence of a non-disintegrated gas with small condensation surface. When these large steam bubbles rapidly implodes, condensation bangs arises that causes vibration in the pipe and in following equipment. This phenomenon limits the amount of steam that can be added to the system and thus the desired increase in temperature. It is hard to achieve a totally even temperature profile in the pulp suspension when large steam bubbles exists. In order to remedy these problems, a large amount of energy can be supplied to carefully admix the steam in the pulp suspension. Another variant is to disintegrate the steam already at the supply in the pulp suspension. In intermixing of bleaching agent in a pulp suspension, relatively large amounts of energy are used in order to provide that the bleaching agent is evenly distributed and conveyed to all the fibres in the pulp suspension. The energy requirements are controlled by which bleaching agent that shall be supplied (rate of diffusion and reaction velocity) and also by the phase of the bleaching medium (liquid or gas). The geometry at supply of the bleaching agent in vapour phase is important in order to avoid unwanted separation immediately a the intermixture.

The object with the present invention is to provide an apparatus for supplying and intermixing of a chemical medium in a pulp suspension in an effective way and that at least partly eliminates the above mentioned problem.

This object is achieved with an apparatus for mixing of a chemical medium in gaseous or liquid state with a pulp suspension according to the present invention. The apparatus comprises a housing having a wall that defines a mixing chamber and a first feeder for feeding the pulp suspension to the mixing chamber. Further, the apparatus comprises a rotor shaft, that extends in the mixing chamber, a drive device for rotation of the rotor shaft and a rotor body that is connected to the rotor shaft. The rotor body is arranged to supply kinetic energy to the pulp suspension flow, during rotation of the rotor shaft by the rotation of the drive device, such that turbulence is produced in a turbulent flow zone in the mixing chamber. The apparatus also comprises a second feeder for feeding of the chemical medium to the mixing chamber and an outlet for discharging the mixture of chemical medium and pulp suspension from the mixing chamber. The apparatus is characterised by that the second feeder comprises a chemical distribution element integrated with the rotor body and arranged to distribute the chemical medium to or to close vicinity to said turbulent flow zone.

In that respect, in accordance with present invention, an even and effective intermixing of the chemical medium in the pulp suspension is provided.

Further features and advantages according to embodiments of the apparatus according to the present invention are evident from the claims and in the following from the description.

The present invention shall now be described more in detail in embodiments, with reference to the accompanying drawings, without restricting the interpretation of the invention thereto, where

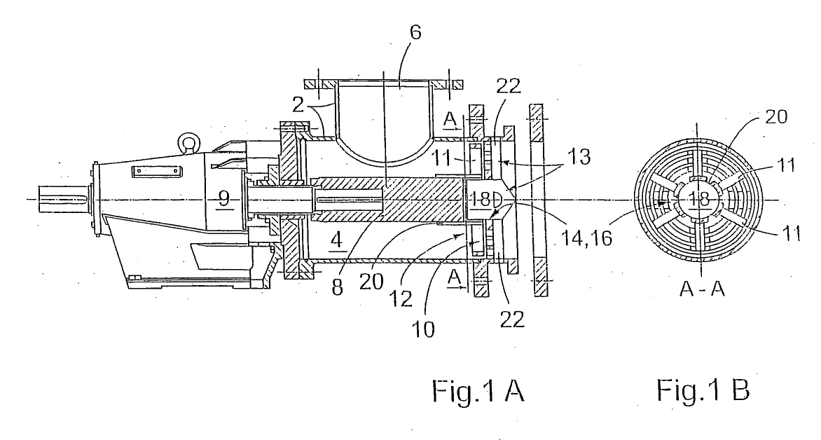

FIG. 1A shows an apparatus in cross-section according to an embodiment of the present invention,

FIG. 1B shows a cross-section A-A of the apparatus according to FIG. 1A,

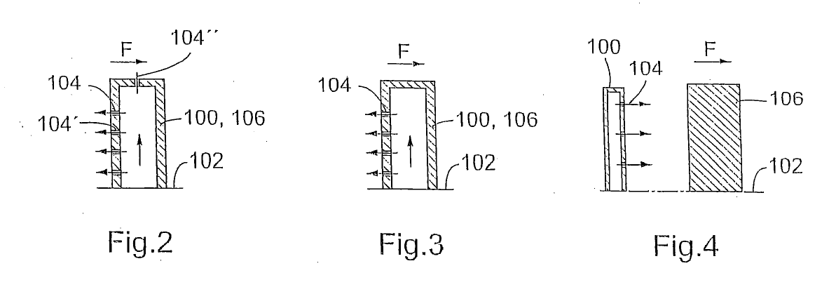

FIG. 2 shows a chemical distribution element according to an embodiment,

FIG. 3 shows a chemical distribution element according to an alternative embodiment,

FIG. 4 shows a chemical distribution element according to yet an alternative embodiment,

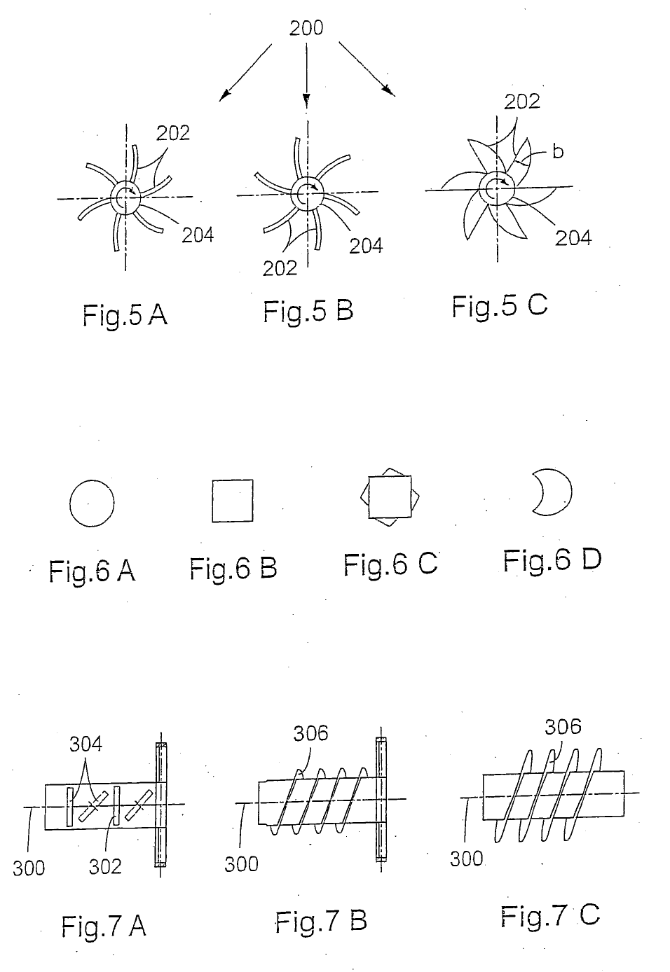

FIG. 5A-C illustrates different alternative embodiments of rotor pins in cross-section of the rotor shaft,

FIG. 6A-D illustrates different alternative cross-sections of rotor pins,

FIG. 7A-C shows schematically alternative embodiments of a rotor shaft provided with axial flow-generating elements,

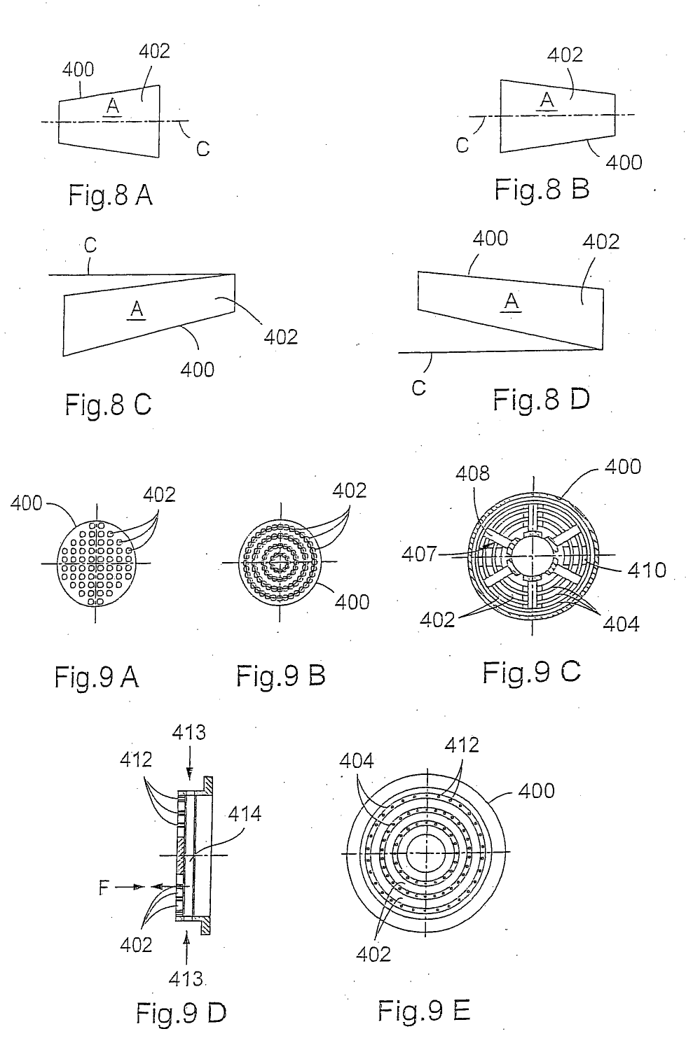

FIG. 8A-D shows schematically alternative embodiments of flow passages in an axial direction of a flow-restraining disk,

FIG. 9A-B shows alternative located patterns of flow passages for a flow-restraining disk,

FIG. 9C shows in one embodiment a flow-restraining disk in axial direction comprising concentrically rings which are coaxial with a rotor shaft,

FIG. 9D shows in a cross-section an embodiment of a flow-restraining disk comprising channels for chemical distribution,

FIG. 9E shows the disk according to FIG. 9D in a front view, and

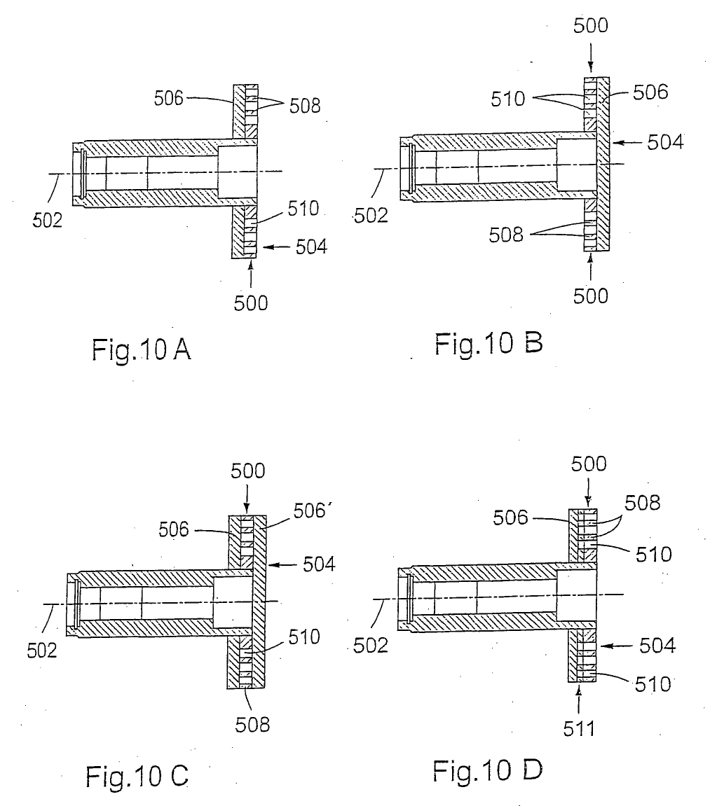

FIG. 10A-D illustrates alternative embodiments of flow-restraining disks integrated with the rotor shaft.

In FIG. 1A-B is shown an apparatus according to an embodiment of the present invention, for a mixture of a chemical medium in gas gaseous or liquid state with a pulp suspension. The apparatus comprises a housing with a wall 2 that defines a mixing chamber 4 and a first feeder 6 for supplying of pulp suspension to the mixing chamber. Further, the apparatus comprises a rotor shaft 8, which extends in the mixing chamber 4, a drive device 9 for rotation of the rotor shaft and a rotor body 10 that is connected to the rotor shaft 8. The rotor body is arranged to supply kinetic energy to the pulp suspension flow, during rotation of the rotor shaft by the rotation of the drive device, such that turbulence is produced in a turbulent flow zone 12 in the mixing chamber. The apparatus also comprises a second feeder 13 for feeding of the chemical medium to the mixing chamber and an outlet (not shown) for discharging the mixture of chemical medium and pulp suspension from the mixing chamber 4. The second feeder 13 comprises a chemical distribution element 14 integrated with the rotor body 10 and arranged to distribute the chemical medium to or to close vicinity to said turbulent flow zone 12.

Preferably, the rotor body 10 comprises a number of rotor pins 11, which extends from the rotor shaft 8. The chemical distribution element 14 comprises at least one chemical outlet 16, suitably situated up-stream of the rotor pins.

As evident from FIG. 2-4, a chemical distribution element may comprise of at least one distribution pipe 100 that extends radial from the rotor shaft 102, whereby chemical outlet(s) 104 is arranged on the distribution pipe 100.

As illustrated in FIG. 4, the chemical outlets 104 may be directed (which is shown by the arrows in FIG. 4) against a rotor pin 106. According to an alternative embodiment, as shown in FIGS. 2 and 3, the chemical distribution element may also comprise at least one chemical outlet 104 arranged on at least one of the rotor pins 106. In that respect, the chemical outlet can be directed (as shown by arrows in FIGS. 2 and 3) in the opposite flow direction F of the pulp suspension along the rotor shaft 102, or directed transverse to the flow direction F of the pulp suspension (not shown). As evident from FIG. 2, the chemical distribution element can comprise a plurality of chemical outlets 104 arranged on at least one of the rotor pins 106, whereby at least one chemical outlet 104′ is directed in the opposite flow direction of the pulp suspension along the rotor shaft and at least one chemical outlet 104″ is transverse the flow direction of the pulp suspension from the rotor shaft 102. The chemical outlets 104 may be designed as cylindrical apertures. Other design, e.g. spray nozzle shape, can be used in order to improve the chemical distribution and prevent the pulp suspension from penetrating upstream in the chemical outlets 104.

With reference again to FIG. 1A-B, the second feeder 13 may comprise a stationary cylindrical body 18, which is coaxial with the rotor shaft 8, and that the rotor body 10 comprises a sleeve 20 that sealingly surrounds the cylindrical body 18, whereby the cylindrical body is provided with a channel for the chemical medium that communicates with the chemical distribution element 14. The second feeder 13 can suitably comprise a connection pipe 22, that extends through the wall 2 of the housing to the stationary cylindrical body 18 and that is connected to the channel therein.

FIG. 5A-C illustrates that a rotor body 200 according to the present invention may comprise a number of rotor pins 202, which extends from the rotor shaft 204 in its radial direction. Each rotor pin may be curved forward from the rotor shaft (FIG. 5A) or backward (FIG. 5B) relatively to the rotational direction of the rotor body (see arrow in FIG. 5A-C), which both embodiments aims to provide a radial conveyance of the mixture. According to an alternative embodiment shown in FIG. 5C, each rotor pin may have a width b, as seen in the rotational direction of the rotor body, that increase along at least a part of the rotor body in direction against the rotor shaft 204. The embodiment according to FIG. 5C decreases the opened area and by that the axial flow velocity increases. The rotor pins 202 can be provided with varying cross-sections as illustrated in FIG. 6A-D. Each rotor pin may be designed with a circular cross-section as shown in FIG. 6A, which is simple from a manufacturing viewpoint and a cost efficient design. The rotor pins 202 may also be provided with a triangular or quadratic cross-section, according to FIG. 6B-C, which geometry creates a dead air space at rotation of the rotor shaft. According to yet an embodiment the rotor pins may be provided with a shovel-shaped cross-section according to FIG. 6D, which results in a sling-effect at rotation of the rotor shaft. In addition, as evident from FIG. 6C, each rotor pin may be designed with a helix shape, suitably with quadratic cross-section, in the axial direction of the rotor pin. Which one of the various designs of the cross-sections of the rotor pins 202 that are most preferable depends on the current flow resistance.

FIG. 7A-C shows alternative embodiments of a rotor shaft 300 provided with one or more axially flow generating elements 302. As is shown in FIG. 7A, the axial flow-generating element can comprise a number of blades 304, which are obliquely attached relatively to the rotor shaft. Rotation of the rotor shaft causes an axial flow. If the elements are of various rotational orientations along the rotor shaft as shown in FIG. 7A, different directions of flow are obtained as well. In addition, the axial flow-generating element can comprise a screw thread or a band thread 306, according to alternative embodiments shown in FIG. 7B-C, which extends along the rotor shaft 300, that aims to force the fluid closest to the hub of the rotor shaft towards some direction. For the feeding, the height of the band can suitably be about 5-35 mm. According to an alternative embodiment the axial flow-generating element can comprise a relatively thin elevation of about 3-6 mm on the surface of the shaft, suitably about 3.8 to 5.9 mm. This scale of lengths is suitably when it corresponds to the characteristic size of the fibre-flocks for kraft pulp at current process conditions. Thus, this should be variable in the process. The size of the flocks can be said to be in inverse proportion to the total work that is added to the fibre suspension.

Preferably, the apparatus comprises a flow-restraining disk 400 with on or more flow passages, having constant axial area, arranged to temporarily increase the flow velocity of the pulp suspension when the pulp suspension passes the flow-restraining disk. The purpose of the disk is to create a controlled fall of pressure. The energy is used for static mixing and the disk is designed for varying pressure recovery depending on desired energy level. FIG. 8A-D shows different alternative embodiments of flow passages 402 in the axial direction of a flow-restraining disk 400. The flow area A of each flow passage increases or decreases in the direction of the flow, which in particular is shown in FIG. 8A-B. FIG. 8A shows a divergent opening, i.e. that an open area enlarges in axial direction. FIG. 8B shows a converging opening, i.e. where the open area diminish in axial direction- As shown in FIG. 8C-D, each flow passage can extend obliquely from the up-stream side of the disk against the centre axis C of the disk.

The flow-restraining disk 400 is preferably provided with a plurality of flow passages 402 as shown in FIG. 9A-C, which passages can be arranged according to a number of alternative placement patterns, radially spread out on the flow-restraining disk. The disk is preferably circular or coaxial with the rotor shaft. The flow passages of the flow-restraining disk may for example form a Cartesian pattern (FIG. 9A) which provides asymmetrical jet streams, or a polar pattern (FIG. 9B). FIG. 9C shows an alternative embodiment where the flow passages 402 of the flow-restraining disk 400 in axial direction are formed of concentrically rings 404 that are coaxial with a rotor shaft 406, and its rotor body 407, which may comprise one or more rotor pins 408, arranged on distance from and ahead of disk 400. The flow-restraining disk is suitably stationary arranged in the housing and the disk may comprise a number of concentrically rings 404, which are coaxial with the rotor shaft 406, and at least one radial bar 410, that fixates the rings 404 relatively each other and that are attached in the wall of the housing, whereby the flow passages 402 are defined by the rings and the bar. According to an embodiment shown in FIG. 9D and 9E, the flow-restraining disk 400 may also comprise channels 412 for distribution of the chemical medium on the down-stream side of the rotor body, directed in the opposite flow direction F of the pulp suspension. Suitably is chemical supply 413 to the channels 412 provided via a radial extending connection pipe 414 in the disk.

However, a flow-restraining disk 500 can be integrated with the rotor shaft 502. FIG. 10A-D illustrates alternative embodiments of flow-restraining disks 500 integrated with the rotor shaft 502. The rotor body 504 may suitably comprise a number of rotor pins 506, which extends from the rotor shaft 502, whereby the disk is fixed to the rotor pins 506 on the down-stream side of the rotor body as shown in FIG. 10A, or on its up-stream side as shown in FIG. 10B. As shown in FIG. 10C, the rotor body may comprise an additional number of pins 506′, that extends from the rotor shaft on the down-stream side of the disk, whereby the disk 500 also is fixed to said additional pins 506′. Preferably, the disk comprise a number of concentrically rings 508, which are coaxial with the rotor shaft, and the rotor pins 506, 506 ′ fixates the rings 508 in relation to each other, whereby flow passages 510 are defined by the pins and the rings. FIG. 10D shows rotor pins 506 and concentrically rings 500. Further, spacer elements 511 are arranged between the rotor pins 506 and the concentrically rings 500. The spacer elements are used in order to move the turbulent zone.

1-33. (canceled)

34. Apparatus for mixing of a chemical medium in gaseous or liquid state with a pulp suspension, comprising a housing having a wall that defines a mixing chamber, a first feeder for feeding the pulp suspension to the mixing chamber, a rotor shaft that extends in the mixing chamber, a drive device for rotation of the rotor shaft, a rotor body that is connected to the rotor shaft and arranged to supply kinetic energy to the pulp suspension flow during rotation of the rotor shaft by the rotation of the drive device, such that turbulence is produced in a turbulent flow zone in the mixing chamber, a second feeder for feeding the chemical medium to the mixing chamber, an outlet for discharging the mixture of chemical medium and pulp suspension from the mixing chamber, a flow-restraining disk in the outlet from the mixing chamber with one or more flow passages arranged to temporarily increase the flow velocity of the pulp suspension when the pulp suspension passes the flow-restraining disk, the second feeder comprising a chemical distribution element integrated with the rotor body and arranged to distribute the chemical medium to within a close vicinity of said turbulent flow zone and said rotor body comprising a number of rotor pins which extend from the rotor shaft on the upstream side of the flow-restraining disk.

35. Apparatus according to claim 34, wherein said chemical distribution element comprises at least one chemical outlet situated upstream of the rotor pins.

36. Apparatus according to claim 35, wherein said chemical distribution element comprises at least one distribution pipe that extends radially from the rotor shaft, whereby the chemical outlet is arranged on the distribution pipe.

37. Apparatus according to claim 34, wherein said chemical distribution element comprises at least one chemical outlet arranged on at least one of the rotor pins.

38. Apparatus according to claim 34, wherein said chemical distribution element comprises a plurality of chemical outlets arranged on at least one of the rotor pins, whereby at least one chemical outlet is directed in the opposite flow direction of the pulp suspension along the rotor shaft and at least one chemical outlet is directed radially outward form the rotor shaft.

39. Apparatus according to claim 35, wherein said second feeder comprises a stationary cylindrical body which is coaxial with the rotor shaft, and wherein said rotor body comprises a sleeve that sealingly surrounds the cylindrical body, whereby the cylindrical body is provided with a channel for the chemical medium that communicates with the chemical distribution element.

40. Apparatus according to claim 34, wherein each rotor pin is curved forwardly from the rotor shaft or backwardly relative to the rotational direction of the rotor body.

41. Apparatus according to claim 34, wherein each rotor pin has a width as seen in the rotational direction of the rotor body that increases along at least a part of the rotor body in a direction against the rotor shaft.

42. Apparatus according to claim 34, wherein said rotor shaft is provided with an axially flow generating element.

43. Apparatus according to claim 42, wherein said axial flow-generating element comprises a number of blades which are obliquely attached relative to the rotor shaft.

44. Apparatus according to claim 42, wherein said axial flow-generating element comprises a screw thread or a band thread which extends along the rotor shaft.

45. Apparatus according to claim 34, wherein each flow passage extends obliquely from the upstream side of the disk against the center shaft of the disk.

46. Apparatus according to claim 34, wherein the disk is stationarily arranged in the housing.

47. Apparatus according to claim 46, wherein said flow-restraining disk comprises channels for distribution of the chemical medium on the downstream side of the rotor body.

48. Apparatus according to claim 46, wherein said disk comprises a number of concentric rings which are coaxial with the rotor shaft and at least one radial bar that fixates the rings relative to each other and that are attached in the wall of the housing, whereby the flow passages are defined by the rings and the bar.

49. Apparatus according to claim 34, wherein said disk is integrated with the rotor shaft.

50. Apparatus according to claim 49, wherein said rotor body comprises a number of pins that extend from the rotor shaft, whereby the disk is fixed to the pins on the downstream side of the rotor body.

51. Apparatus according to claim 50, wherein said rotor body comprises an additional number of pins that extend from the rotor shaft on the downstream side of the disk, whereby the disk is also fixed to said additional pins.

52. Apparatus according to claim 50, wherein said disk comprises a number of concentric rings which are coaxial with the rotor shaft and the rotor pins fixate the rings in relation to each other, whereby flow passages are defined by the pins and the rings.

53. apparatus according to claim 49, including spacer elements arranged between the disk and the rotor pins.
